(19) United States
(12) Patent Application Publication
(10) Pub. No.: US 2019/0254051 A1
(43) Pub. Date: Aug. 15, 2019

(54) Configured Physical Uplink Shared Channel (PUSCH) Opportunities with Activation

(71) Applicant: MEDIATEK INC., Hsinchu (TW)

(72) Inventors: Xiu-Sheng Li, Hsinchu (TW); Wei-De Wu, Hsinchu (TW)

(21) Appl. No.: 16/264,947

(22) Filed: Feb. 1, 2019

Related U.S. Application Data
(60) Provisional application No. 62/629,734, filed on Feb. 13, 2018.

(51) Int. Cl. H04W 72/12; H04W 28/26

(52) U.S. Cl. CPC H04W 72/1268; H04W 72/1205; H04W 28/26

(57) ABSTRACT

Apparatus and methods are provided for configured PUSCH opportunities with activation. In one novel aspect, a plurality of PUSCH opportunities and one or more activation opportunities are configured. The UE triggers one or more PUSCH opportunities for UL data transmission using an activation signal transmitted at one of the configured activation opportunities and transmits UL data on one or more PUSCH resources configured by the PUSCH opportunities associated with the activation opportunity on which the activation signal is transmitted. In one embodiment, the activation signal is a L1 signal or a scheduling request. The dynamic scheduling may or may not be used for data transmission. In one embodiment, the configured PUSCH opportunities are available for data transmission by dynamic scheduling until detecting one or more disabling conditions. In another embodiment, the configured PUSCH opportunities are not available for data transmission until detecting one or more enabling conditions.

### CROSS REFERENCE TO RELATED APPLICATIONS

This application claims priority under 35 U.S.C. § 119 U.S. provisional application 62/629,734, entitled “CONFIGURED PUSCH OPPORTUNITIES WITH ACTIVATION” filed on Feb. 13, 2018, the subject matter of which is incorporated herein by reference.

### TECHNICAL FIELD

The disclosed embodiments relate generally to wireless communication, and, more particularly, to configured physical uplink shared channel (PUSCH) opportunities with activation.

### BACKGROUND

Mobile networks communication continues to grow rapidly. The mobile data usage will continue skyrocketing. New data applications and services will require higher speed and more efficient. In particular, the uplink (UL) data transmission scheduling requires either a dynamic scheduling with additional power consumption or with semi persistence scheduling, which lacks the flexibility.

In the existing wireless system there are two schemes for UL data scheduling. The first is the scheduling request (SR) based UL transmission. The UE sends a SR to the network when there are data to be transmitted. During discontinuous reception (DRX) mode, the UE needs to monitor for the first UL transmission resulting in additional power consumption and downlink control information (DCI) overhead. Using the SR method, to save the power consumption and reduce the DCI overhead, the UE may only monitor the UL transmission during DRX on period. However, this approach introduces UL latency and would not work for data transmissions with low latency or ultra-low latency (ULL) requirements. The second method for UL data transmission scheduling is using the UL semi-persistent scheduling (SPS), where periodic PUSCH opportunities are configured. The UE can transmit UL data at the first available configured PUSCH opportunity. The SPS approach is not flexible. To avoid collision, the network may need to reserve the PUSCH resources, which result in resource waste.

Improvements and enhancements are required for UL data scheduling that is flexible, reduces signaling overhead and is resource efficient.

### SUMMARY

Apparatus and methods are provided for configured PUSCH opportunities with activation. In one novel aspect, a plurality of PUSCH opportunities and one or more activation opportunities are configured. The UE triggers one or more PUSCH opportunities for UL data transmission using an activation signal transmitted at one of the configured activation opportunities and transmits UL data on one or more PUSCH resources configured by the PUSCH opportunities associated with the activation opportunity on which the activation signal is transmitted. In one embodiment, the activation signal is a layer-one (L1) signal. In another embodiment, the activation signal is a scheduling request (SR). In one embodiment, the configured PUSCH opportunities are periodic. In one embodiment, the configured activation opportunities follow a predefined pattern. In another embodiment, the configured activation opportunities are periodic. In yet another embodiment, each periodic activation opportunity is associated with one or more periodic PUSCH opportunities.

In one embodiment, the dynamic scheduling is not used for data transmission following the configured PUSCH opportunities with activation. In another embodiment, the dynamic scheduling is used for data transmission following the configured PUSCH opportunities with activation. In one embodiment, the activation signal triggers a number N of PUSCH opportunities for data transmission. In another embodiment, the activation signal triggers all following PUSCH opportunities for data transmission until detecting one or more disabling conditions comprising: the UE has no more UL data to transmit and a disabling signaling is received from the wireless network. In one embodiment, the configured PUSCH opportunities are available for data transmission together with dynamic scheduling until detecting one or more disabling conditions comprising: the UE has no more UL data to transmit and a disabling signaling is received from the wireless network. In yet another embodiment, the following configured PUSCH opportunities are not available and only dynamic scheduling is used until the UE UL data buffer becomes empty, and has new UL data to transmit. The UE subsequently triggers the configured PUSCH opportunities again by an activation signal.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a system diagram of a wireless network using configured PUSCH opportunities with activation in accordance with embodiments of the current invention.

FIG. 2 illustrates an exemplary resource allocation 200 for the activation opportunities and the PUSCH opportunities in accordance with embodiments of the current invention.

FIG. 3 illustrates an exemplary block diagram for the configured PUSCH opportunities with activation in the DRX mode in accordance with embodiments of the current invention.

FIG. 4 illustrates an exemplary block diagram for data transmission following the configured PUSCH opportunities with activation in accordance with embodiments of the current invention.

FIG. 5A illustrates an exemplary diagram for a no-dynamic scheduling scheme with a predefined number N of PUSCH opportunities enabled in accordance with embodiments of the current invention.

FIG. 5B illustrates an exemplary diagram for a no-dynamic scheduling scheme with all PUSCH opportunities enabled until at least one disabling condition is met in accordance with embodiments of the current invention.

FIG. 6A illustrates an exemplary diagram for a dynamic scheduling scheme where the configured PUSCH opportunities can be used for the following UL transmission until at least one disabling condition is met in accordance with embodiments of the current invention.

FIG. 6B illustrates an exemplary diagram for a dynamic scheduling scheme where the configured PUSCH opportunities cannot be used for the following UL transmission until at least one enabling condition is met in accordance with embodiments of the current invention.

FIG. 7 is an exemplary flow chart for the configured PUSCH opportunities with activation procedure in accordance with embodiments of the current invention.

### DETAILED DESCRIPTION

Reference will now be made in detail to some embodiments of the invention, examples of which are illustrated in the accompanying drawings.

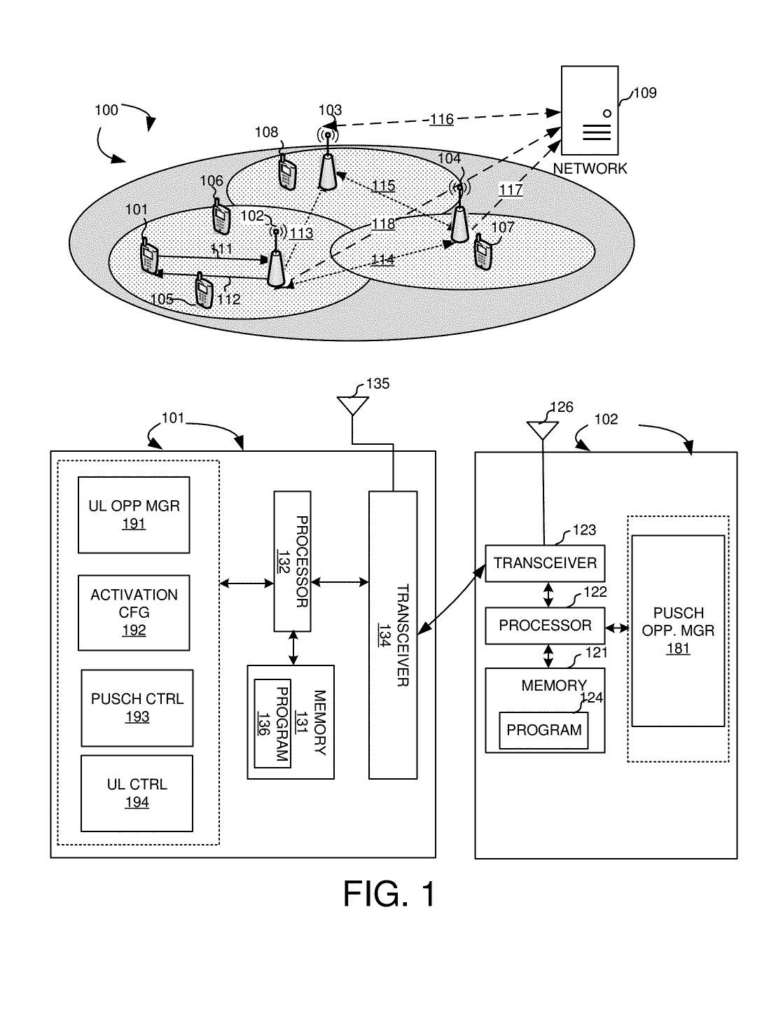

FIG. 1 illustrates a system diagram of a wireless network 100 using configured PUSCH opportunities with activation in accordance with embodiments of the current invention. Wireless communication system 100 includes one or more wireless networks each of the wireless communication network has fixed base infrastructure units, such as receiving wireless communications devices or base unit 102 103, and 104, forming wireless networks distributed over a geographical region. The base unit may also be referred to as an access point, an access terminal, a base station, a Node-B, an eNode-B, a gNB, or by other terminology used in the art. Each of the base unit 102, 103, and 104 serves a geographic area. Backhaul connections 113, 114 and 115 connect the non-co-located receiving base units, such as 102, 103, and 104. These backhaul connections can be either ideal or non-ideal

A wireless communications device 101 in wireless network 100 is served by base station 102 via uplink 111 and downlink 112. Other UEs 105, 106, 107, and 108 are served by different base stations. UEs 105 and 106 are served by base station 102. UE107 is served by base station 104. UE 108 is served by base station 103.

In one novel aspect, the UE configures periodic PUSCH opportunities with activation. In one embodiment, the activation signal is a layer-one (L1) signal. In another embodiment, the activation signal is the SR signal. The UE, upon determining that there are UL data to be transmitted, triggers one or more PUSCH opportunities with the activation signal using the configured activation opportunity. The overhead for the resource reservation for the activation signaling is much smaller than the PUSCH resource reservation for the SPS method. The UE does not need to monitor during the DRX off period for the first UL transmission. With the activation signaling for the UL resources, the UE can achieve low latency with less overhead and more efficiency.

FIG. 1 further shows simplified block diagrams of wireless device/UE 101 and base station 102 in accordance with the current invention.

Base station 102 has an antenna 126, which transmits and receives radio signals. A RF transceiver module 123, coupled with the antenna, receives RF signals from antenna 126, converts them to baseband signals and sends them to processor 122. RF transceiver 123 also converts received baseband signals from processor 122, converts them to RF signals, and sends out to antenna 126. Processor 122 processes the received baseband signals and invokes different functional modules to perform features in base station 102. Memory 121 stores program instructions and data 124 to control the operations of base station 102. Base station 102 also includes a set of control modules, such as a PUSCH opportunity manager 181 that configures PUSCH activation and PUSCH opportunities and communicates with the UE to implement the configured PUSCH opportunity activation functions. The PUSCH opportunity manager can be implemented in hardware, software, and firmware and can be implemented in one or more circuits.

UE 101 has an antenna 135, which transmits and receives radio signals. A RF transceiver module 134, coupled with the antenna, receives RF signals from antenna 135, converts them to baseband signals and sends them to processor 132. RF transceiver 134 also converts received baseband signals from processor 132, converts them to RF signals, and sends out to antenna 135. Processor 132 processes the received baseband signals and invokes different functional modules to perform features in mobile station 101. Memory 131 stores program instructions and data 136 to control the operations of mobile station 101.

UE 101 also includes a set of control modules that carry out functional tasks. These functions can be implemented in software, firmware and hardware and can be implemented in one or more circuits. An UL opportunity manager 191 configures a plurality of physical uplink shared channel (PUSCH) opportunities. An activation configurator 192 configures one or more activation opportunities, wherein each activation opportunity is associated with one or more configured PUSCH opportunities. A PUSCH controller 193 triggers one or more PUSCH opportunities for UL data transmission using an activation signal transmitted at one of the configured activation opportunities. An UL controller 194 transmits UL data on one or more PUSCH resources configured by the PUSCH opportunities associated with the activation opportunity on which the activation signal is transmitted.

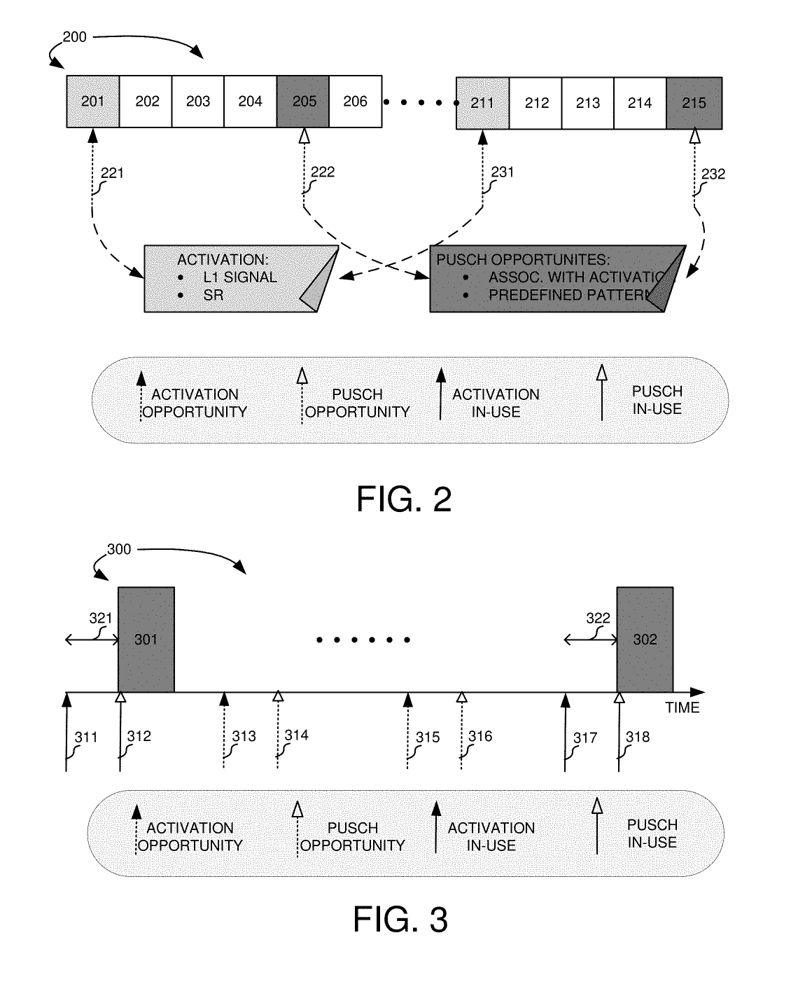

FIG. 2 illustrates an exemplary resource allocation 200 for the activation opportunities and the PUSCH opportunities in accordance with embodiments of the current invention. Resources 201 to 206 and 211 to 215 are exemplary resource blocks. In one novel aspect, activation opportunities 201 and 211 are configured for the UE. The UE can send resource requests during the activation opportunities with an activation signal. In one embodiment, the activation signal 221 or 231 in resource 201 or 211, respectively is an L1 signal. The L1 signal can be a new defined L1 signal indicating UL PUSCH reservation. In another embodiment, the activation signal 221 or 231 in resource 201 or 211, respectively, is an SR. In one embodiment, PUSCH opportunities 222 and 232 corresponding to resources 205 and 215, respectively, are associated with each activation signal. In one embodiment, the PUSCH opportunities associated with each activation signal is periodic. In another embodiment, the PUSCH opportunities associated with each activation signal is allocated with predefined/preconfigured pattern. When the UE needs to transmit UL data, the UE informs the network with an activation signal to reserve the following PUSCH opportunities. The UE subsequently transmits UL data on the PUSCH as its first UL transmission for UL data. The configured exemplary activation opportunities 221 and 231 corresponding to resource blocks 201 and 211, respectively and requires much less resource than the PUSCH reservation for SPS.

FIG. 3 illustrates an exemplary block diagram 300 for the configured PUSCH opportunities with activation in the DRX mode in accordance with embodiments of the current invention. For the conventional SR method, the UE needs to monitor the first UL transmission during the DRX off period when there is a low latency requirement. Periods 301 and 302 are exemplary DRX on duration and the rest are DRX off duration. In one novel aspect, the configured PUSCH opportunity with activation scheduling does not require the monitoring during the off duration. As shown, activation opportunities 311, 313, 315, and 317 are configured. The UE can use the configured activation opportunities to reserve PUSCH resources. The exemplary PUSCH resources 312, 314, 316, and 318 are preconfigured to be associated with the configured activation opportunities. When the UE sends UL request during the activation opportunity during the DRX off duration, the UE does not need to wake up to monitor the first UL transmission. The UE can transmit the UL data on the first UL PUSCH opportunity configured to be associated with the activation opportunity. The UE at activation opportunity 311 sends an activation signal for UL data transmission resources. Activation opportunity 311 is during the DRX off duration. The UE does not need to wake up in the duration 321. The UE transmits its first UL data at configured PUSCH opportunity 312. Similarly, activation opportunity 317 is during the DRX off duration. The UE does not need to wake up in the duration 322. The UE transmits its first UL data at configured PUSCH opportunity 318. As shown, the configured PUSCH opportunities with activation do not require monitoring during the DRX off duration and save power consumption. There is no DCI overhead required either. In another scenario, for URLLC application, the traditional UL scheduling requires huge PUSCH resource reservation to achieve the reliable and immediate/ULL transmission. With the configured PUSCH opportunities with activation scheduling, the low latency is achieved by the flexibility provided by the configured activation opportunities. Large PUSCH resources are not required until the UL transmission is activated by the activation signal. The resource efficiency is improved.

Once the configured PUSCH opportunities with activation are triggered, for following new transmission, the UE can use dynamic scheduling to request new resources. Alternatively, the UE would not use the dynamic scheduling for data transmission. In one embodiment, the retransmission of the data transmission triggered by the configured PUSCH opportunities with activation uses the dynamic scheduling. The new transmission followed by the configured PUSCH opportunities with activation for the UE can be configured.

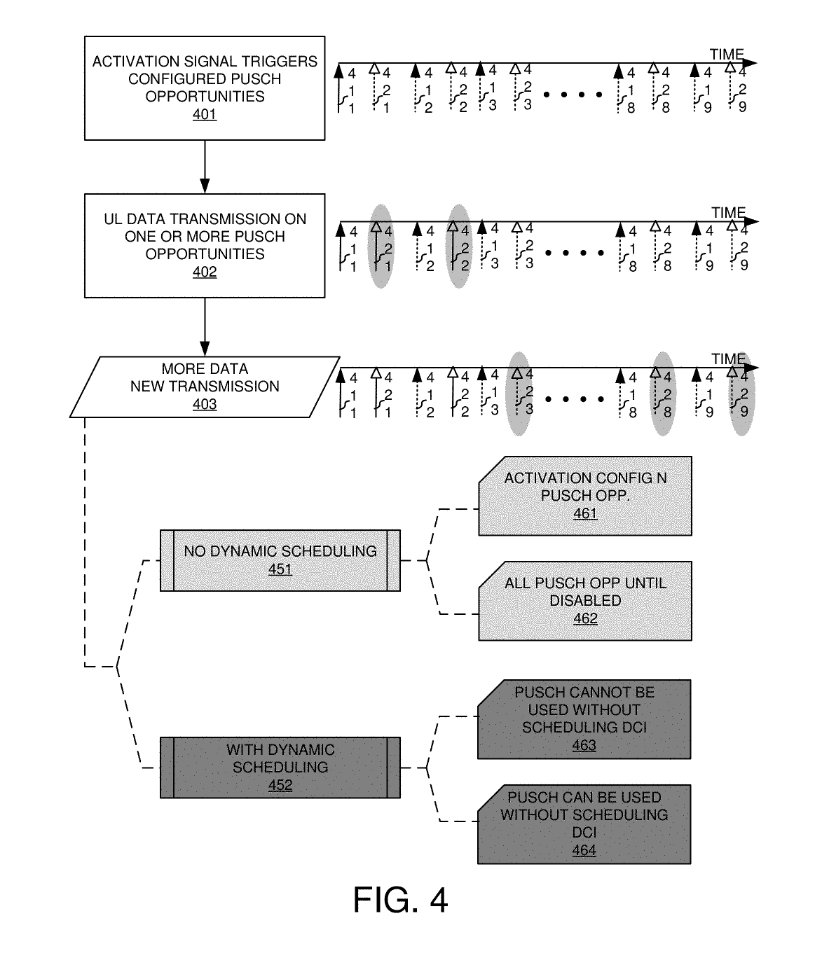

FIG. 4 illustrates an exemplary block diagram for data transmission following the configured PUSCH opportunities with activation in accordance with embodiments of the current invention. In one embodiment, the configured PUSCH opportunities with activation may trigger following dynamic scheduling. In another embodiment, the dynamic scheduling will not be triggered for data transmission following the configured PUSCH opportunities with activation. The UE is configured with activation opportunities 411, 412, 413, 418, and 419. PUSCH opportunities 421, 422, 423, 428, and 429 are also configured. The illustrated configuration is exemplary. One or more PUSCH opportunities are configured to be associated with the activation signaling/opportunities. The PUSCH opportunities can be periodic or with predefined patterns. At step 401, the UE sends an activation signal to the network at 411 to request for PUSCH opportunities. At step 402, the UE starts UL data transmission on one or more configured PUSCH opportunities associated with the activation signal 411. In one exemplary configuration, PUSCH opportunities 421 and 422 are triggers for UL data transmission if the activation signal triggering more than one configured PUSCH opportunities. At step 403, the UE detects more date for data transmission which may use PUSCH opportunities 423, 428 and 429, if all these configured PUSCH opportunities have been triggered by activation signal 411. If the activation signal 411 triggers only one configured PUSCH opportunity 421 or two opportunities 421 and 422, UE has to send activation signal again to use the following configured PUSCH opportunities. In one embodiment, no dynamic scheduling is triggered following the configured PUSCH opportunities with activation and step 451 is triggered for data transmission. In another embodiment, dynamic scheduling is triggered following the configured PUSCH opportunities with activation and step 452 is triggered for data transmission.

In one embodiment, no dynamic scheduling 451 mechanism follows a pre-configuration scheme 461, where a predefined number N of PUSCH opportunities are activated by the activation signal 411. In one embodiment, the number N for the PUSCH opportunities is configured by a higher layer signal. In another embodiment, no dynamic scheduling 451 mechanism follows a disabling scheme 462, where all PUSCH opportunities are activated by the activation signal 411. These activated PUSCH opportunities are disabled if one or more conditions are met. In one embodiment, the activated PUSCH opportunities are disabled if the UE has no more UL data to transmit. In another embodiment, the activated PUSCH opportunities are disabled if a disabling signal is received from the network. In yet another embodiment, subsequently following the disabling signal from the network, an enabling signaling can be received from the network to enable the configured PUSCH opportunities again. In one embodiment, the disabling signal and/or the enabling signal is a higher layer signaling. In another embodiment, the disabling signal and/or the enabling signal is an L1 signaling.

In one embodiment, dynamic scheduling 452 mechanism follows a scheme 463, where the configured PUSCH opportunities can be used for the following UL transmission until at least one disabling condition is met. In another embodiment, dynamic scheduling 452 mechanism follows a scheme 464, where the configured PUSCH opportunities cannot be used for the following UL transmission until at least one enabling condition is met.

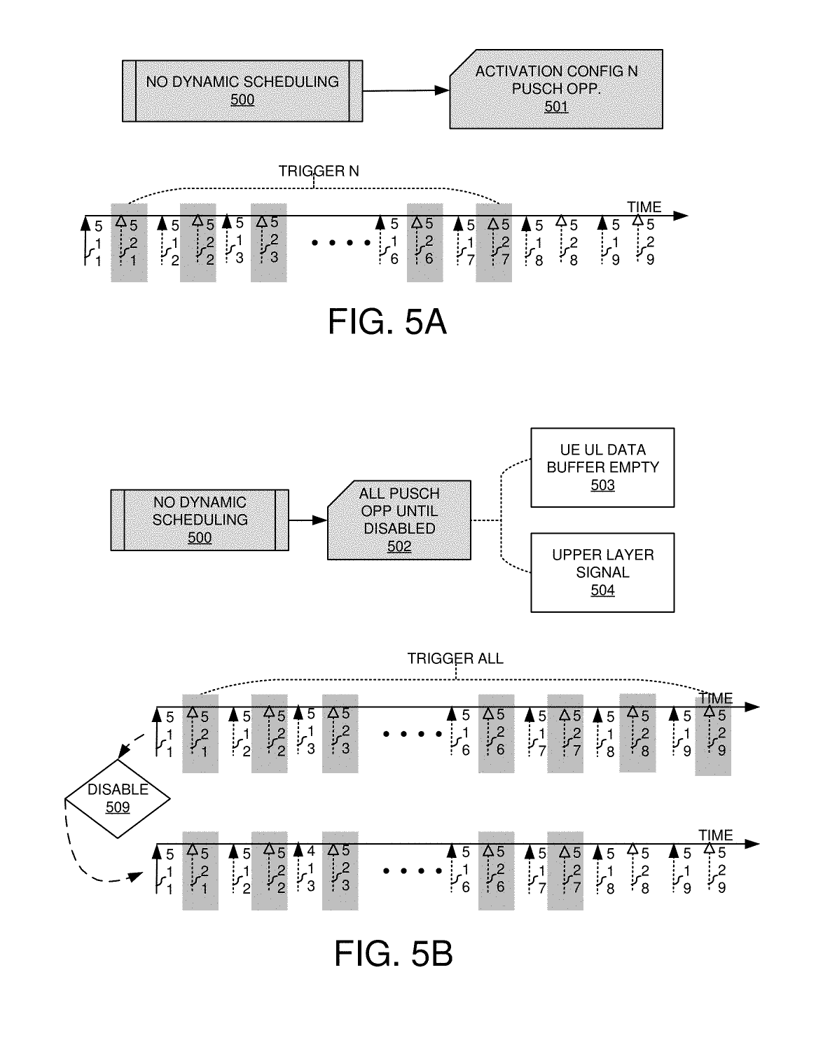

FIG. 5A illustrates an exemplary diagram for a no-dynamic scheduling scheme 500 with a predefined number N of PUSCH opportunities enabled 501 in accordance with embodiments of the current invention. Exemplary activation opportunities 511, 512, 513, 516, 517, 518, and 519 are configured. Exemplary PUSCH opportunities 521, 522, 523, 526, 527, 528, and 529 are configured. An activation signal is sent at 511. In one embodiment, when no dynamic scheduling is used for data transmission, the activation signal at 511 triggers following number N PUSCH opportunities. As an example, PUSCH opportunities 521, 522, 523, 526, 527 are triggered. The data transmission can use the triggered PUSCH opportunities. In one embodiment, the number N is configured by a higher layer signal.

FIG. 5B illustrates an exemplary diagram for a no-dynamic scheduling scheme 500 with all PUSCH opportunities enabled until at least one disabling condition is met 502 in accordance with embodiments of the current invention. Exemplary activation opportunities 511, 512, 513, 516, 517, 518, and 519 are configured. Exemplary PUSCH opportunities 521, 522, 523, 526, 527, 528, and 529 are configured. An activation signal is sent at 511. In one embodiment, the PUSCH opportunities are disabled when the UL data buffer for the UE is empty as in step 503. In another embodiment, the PUSCH opportunities are disabled when a disabling signal is received by the UE as in step 504. In one embodiment, the disabling signal is a higher layer signal. In another embodiment, the disabling signal is a L1 signal. In one embodiment, when no dynamic scheduling is used for data transmission, the activation signal at 511 triggers all following PUSCH opportunities and these opportunities may be disabled when at least one condition is met. As an example, all PUSCH opportunities 521, 522, 523, 526, 527, 528, and 528 are triggered. At step 509, at least one disabling condition is detected. One or more PUSCH opportunities, such as 528 and 529 are disabled for data transmission. In yet another embodiment, the disabled PUSCH opportunities can be further enabled by higher layer signaling or other L1 signals.

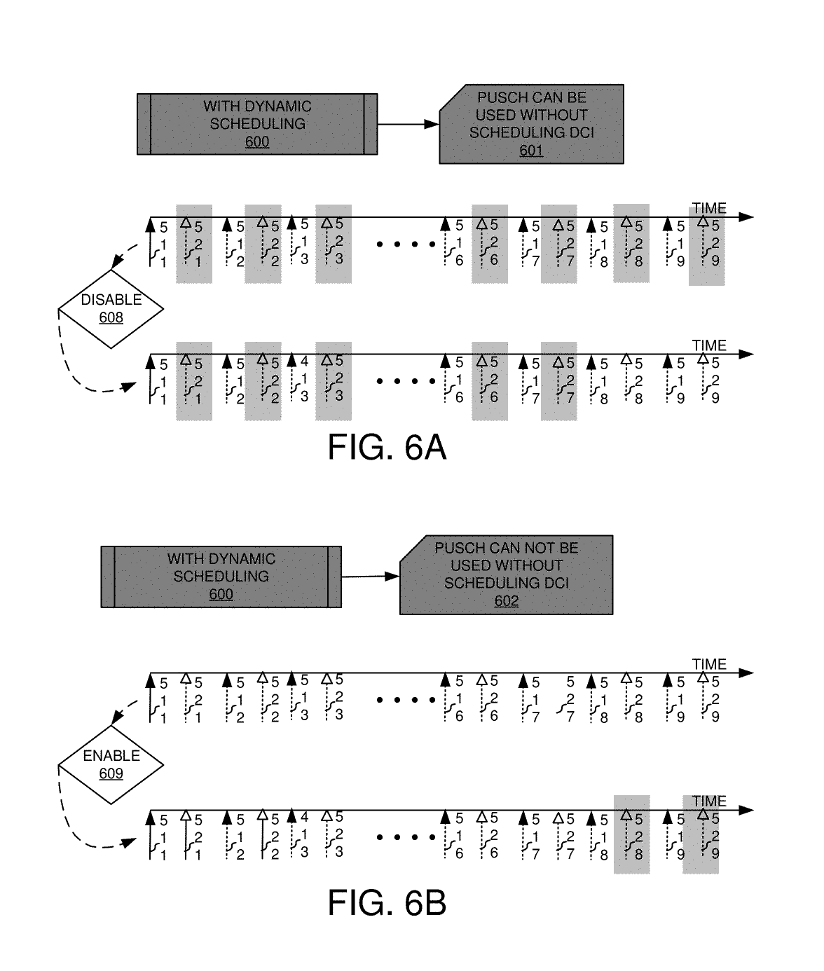

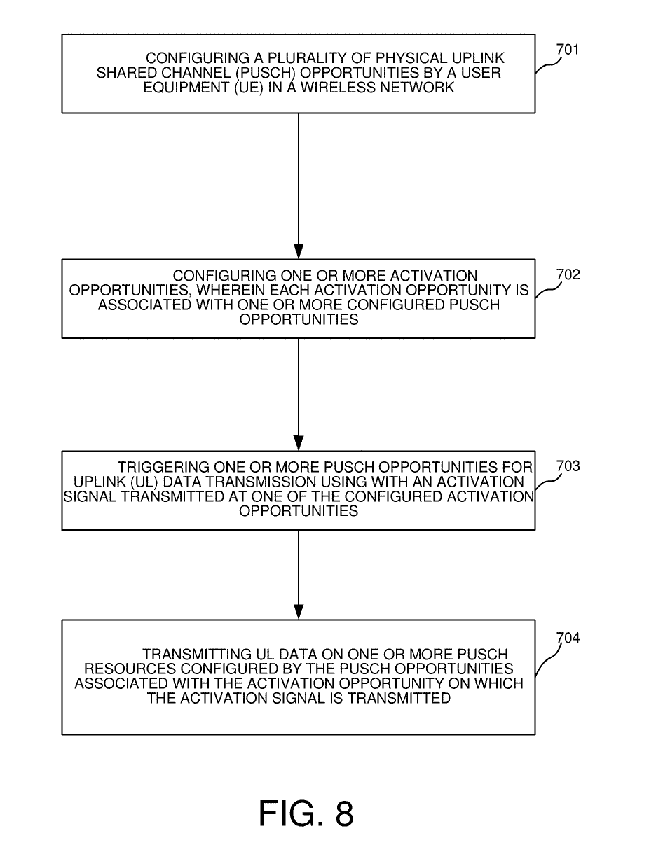

FIG. 6A illustrates an exemplary diagram for a dynamic scheduling scheme 600 where the configured PUSCH opportunities can be used 601 for the following UL transmission until at least one disabling condition is met in accordance with embodiments of the current invention. Exemplary activation opportunities 511, 512, 513, 516, 517, 518, and 519 are configured. Exemplary PUSCH opportunities 521, 522, 523, 526, 527, 528, and 529 are configured. An activation signal is sent at 511. As shown all the configured PUSCH opportunities can be used without scheduling DCI. At step 608, at least one disabling condition is detected. The PUSCH opportunities, such as 528 and 529, are disabled. In one embodiment, the disabling condition is when the UE UL data buffer becomes empty. Whenever the UE has again UL data to transmit, the UE may activate the PUSCH opportunities by activation signal again. In another embodiment, the network may disable the configured PUSCH opportunities, and the network may subsequently enable the PUSCH opportunities. The UE may again transmit the activation signal to use the PUSCH opportunities. The disabling and/or the enabling signaling from the network can be a higher layer signal or other L1 signals.

FIG. 6B illustrates an exemplary diagram for a dynamic scheduling scheme 600 where the configured PUSCH opportunities cannot be used 602 for the following UL transmission until at least one enabling condition is met in accordance with embodiments of the current invention. Exemplary activation opportunities 511, 512, 513, 516, 517, 518, and 519 are configured. Exemplary PUSCH opportunities 521, 522, 523, 526, 527, 528, and 529 are configured. An activation signal is sent at 511. PUSCH opportunities 521 is used for the first UL data transmission. As shown none of the configured PUSCH opportunities (except 521) can be used without scheduling DCI. To use these resources for data transmission or retransmission dynamic scheduling with scheduling DCI is used. In one embodiment, whenever the UE UL data buffer becomes empty, and the UE has again UL data to transmit, the UE may activate the PUSCH opportunity by activation signal again. As shown in FIG. 6B, the UE again uses activation signal 518 to activate the configured PUSCH opportunity 528.

FIG. 7 is an exemplary flow chart for the configured PUSCH opportunities with activation procedure in accordance with embodiments of the current invention. At step 701, the UE configures a plurality of PUSCH opportunities in a wireless network. At step 702, the UE configures one or more activation opportunities, wherein each activation opportunity is associated with one or more configured PUSCH opportunities. At step 703, the UE triggers one or more PUSCH opportunities for UL data transmission using an activation signal transmitted at one of the configured activation opportunities. At step 704, the UE transmits UL data on one or more PUSCH resources configured by the PUSCH opportunities associated with the activation opportunity on which the activation signal is transmitted.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
configuring a plurality of physical uplink shared channel (PUSCH) opportunities by a user equipment (UE) in a wireless network;
configuring one or more activation opportunities, wherein each activation opportunity is associated with one or more configured PUSCH opportunities;
triggering one or more PUSCH opportunities for uplink (UL) data transmission using an activation signal transmitted at one of the configured activation opportunities; and
transmitting UL data on one or more PUSCH resources configured by the PUSCH opportunities associated with the activation opportunity on which the activation signal is transmitted.

2. The method of claim 1, wherein the activation signal is a layer-one (L1) signal.

3. The method of claim 1, wherein the activation signal is a scheduling request (SR).

4. The method of claim 1, wherein configured PUSCH opportunities are periodic.

5. The method of claim 1, wherein the configured activation opportunities are periodic.

6. The method of claim 5, wherein each periodic activation opportunity is associated with one or more periodic PUSCH opportunities.

7. The method of claim 1, wherein the configured PUSCH/activation opportunities follows a predefined pattern.

8. The method of claim 1, wherein the activation signal triggers a number N of PUSCH opportunities for data transmission.

9. The method of claim 8, wherein the number N is configured by a higher layer configuration.

10. The method of claim 1, wherein the activation signal triggers all following PUSCH opportunities for data transmission until detecting one or more disabling conditions comprising: the UE has no more UL data to transmit and a disabling signaling is received from the wireless network.

11. The method of claim 1, wherein a subsequent dynamic scheduling is triggered for remaining UL transmission.

12. A user equipment (UE), comprising:
a wireless radio frequency (RF) transceiver that transmits and receives wireless signal in a wireless network;
an uplink (UL) opportunity manager that configures a plurality of physical uplink shared channel (PUSCH) opportunities;
an activation configurator that configures one or more activation opportunities, wherein each activation opportunity is associated with one or more configured PUSCH opportunities;
a PUSCH controller that triggers one or more PUSCH opportunities for UL data transmission using an activation signal transmitted at one of the configured activation opportunities; and
an UL controller that transmits UL data on one or more PUSCH resources configured by the PUSCH opportunities associated with the activation opportunity on which the activation signal is transmitted.

13. The UE of claim 12, wherein the activation signal is one selected from a signaling group comprising a layer-one (L1) signal and a scheduling request (SR).

14. The UE of claim 12, wherein configured PUSCH opportunities are periodic.

15. The UE of claim 12, wherein the activation signal triggers a number N of PUSCH opportunities for data transmission.

16. The UE of claim 15, wherein the number N is configured by a higher layer configuration.

17. The UE of claim 12, wherein the activation signal triggers all following PUSCH opportunities for data transmission until detecting one or more disabling conditions comprising: the UE has no more UL data to transmit and a disabling signaling is received from the wireless network.

18. The UE of claim 12, wherein a subsequent dynamic scheduling
Is triggered for remaining UL transmission.

19. The UE of claim 12, wherein the configured activation opportunities are periodic.

20. The UE of claim 19, wherein each periodic activation opportunity is associated with one or more periodic PUSCH opportunities.
